(19) United States
(12) Patent Application Publication
(10) Pub. No.: US 2007/0226078 A1
(43) Pub. Date: Sep. 27, 2007

(54) GUIDING INFO TABS WITH GUIDE SELECTION

(75) Inventor: Nagendra Nagarajayya, Pleasanton, CA (US)

Correspondence Address: Mr.Nagendra Nagarajayya, 4302 Denker Dr, Pleasanton, CA, 94588, US

(73) Assignee: TRANSAXTIONS LLC, Pleasanton, CA (US)

(21) Appl. No.: 11/308,093

(22) Filed: Mar. 6, 2006

(51) Int. Cl. G06Q 30/00; G06F 17/30; G07F 7/00

(52) U.S. Cl. 705/27

(57) ABSTRACT

Every presence has needs. A need could be consumer electronics, loans, autos, or knowledge, etc. The presence uses search engines, online marketplace to become knowledgeable about a need and if needed, buy the need. The idea of the invention is to provide an easy way for the user to become knowledgeable about a category or a product and be able to select a product using guide selections. The user can also input the guide selections matching guiding information and input with color coded tabs.

### CROSS-REFERENCE TO RELATED APPLICATIONS

This application claims priority of U.S. Provisional Application, No. 60/656,645, titled “Guiding Info Tabs With Guide Selections” filed 02/23/05 by the present applicant.

This application references U.S. patent application, Ser. No. 11/306332, titled “Intelligent Search With Guiding Info” filed Dec. 22, 2005 by the present applicant.

This application references U.S. patent application Ser. No. 1/161,897, titled “Obtaining A Need With Guiding Information And Credit Worthiness Using A Competitive Process” filed Aug. 22, 2005 by the present applicant.

### FIELD OF THE INVENTION

The present invention relates to searching and online e-commerce on the intranet and the internet. Online e-commerce and search with guiding information tabs and guide selections, enables a user to be knowledgeable and input in multiple ways.

### BACKGROUND OF THE INVENTION

An internet auction instead of taking place in an auction house takes place on the internet. Buyers and Sellers make available the need to sell an item or buy an item over the internet. The buyers and sellers could now be spread across the globe to be part of the auction. A seller makes available an item for auction after registering with an internet auction site. The buyers participate in the auction on the internet and can simultaneously bid on an item. If it is a normal auction, the highest bidder wins the auction and not the last bidder. If it is a Dutch or a Reverse auction, the lowest bidder wins the auction.

The normal auction process, reverse auction process including the Dutch auction process all have flaws. In a normal auction, a buyer might pay a lot more when similar products are available in stores. Prof. Richard Freeman, co-director of the “Center for Economic Performance at the London School of Economics ” and Harvard professor, is looking at user behavior at internet auctions. He warns that users get excited and often bid too high called the winner's curse. In Christmas 2000, Sony Playstations were being sold at inflated prices at internet auctions while High Street stores were selling it at reasonable prices. Cautionary tales abound of hapless shoppers unable to control their obsession and caught in bidding wars for items that they did not want. In a New York Times piece, Michelle Slatalla confesses of buying an item for $2300 when she set out to buy a used system for $800. Reverse auctions on the other hand allow the buyer to set a price and bidding to be initiated by the sellers. But a buyer not knowing the market information can set too high a price for a product and buy at above market prices. Sellers might employ collective selling to keep bid prices high. The buyer bidding in a Dutch auction does not know if the bid made is a reasonable bid. A Buyer in an auction might not be very knowledgeable about an item, or if the item is a popular item, or the market information for the item like the low price or average price for a region. They have to do their own research and end up buying items that they might not need or paying a high price for it instead of a reasonable price. Reverse Auctions also introduce deterioration in buyer/seller relationship due to falling prices.

When a user searches for “Taco Bell” or “Panasonic TV” or “Laptop computer” or “need a mortgage loan”, the user is expecting to get information related to finding the restaurant “Taco Bell”, or buying a “Panasonic TV” or a “Laptop computer” or information about a “mortgage loan”. A user searching for “Panasonic TV” expects to see the popular models, models on sale, market competitive information, information about TVs, LCD TVs, etc. A user searching for a “Laptop computer” is interested in knowing more about a laptop computer, a computer, different models on sale, popular selections, market information, etc. For a “mortgage loan” or “need a mortgage loan” the user might be interested in, what is a mortgage loan?, types of loan products, current interest rates, different mortgage brokers, bankers, market competitive information, etc. A user searching for “relief from cough” or “tantrums 10 yr old” is looking to find information related to finding an immediate relief to the cough or how to overcome the tantrums thrown by the 10 yr old. The search engines with natural language ability do try to understand the context but again might not present the information needed by the user.

A definite need exists for Guiding Information with Guide Info tabs and Guide Selections to overcome the problems associated and described above. Guiding Information, patent pending U.S. application Ser. No. 11/161,897 provides expert information about a category and sub category along with market competitive information. Guide Info tabs with Guide Selections adds to this by presenting the user with popular selections and allowing the user to associate input with these selections and become knowledgeable. The primary purpose of the present invention is to solve these needs and to provide further, related advantages.

### BRIEF DESCRIPTION OF THE INVENTION

Every presence has needs. A need could be consumer electronics, loans, autos, or knowledge, etc. The presence uses search engines, online marketplace to become knowledgeable about the need and if needed purchase the need. The invention allows an online user to become knowledgeable about the market through guiding information and guide selections. The user is guided through color coded tabs allowing the user to match input and guiding information sections. The user can also input a guide selection making the buying process very easy.

### BRIEF DESCRIPTION OF THE DRAWINGS

The accompanying drawings, which are incorporated into and constitute a part of this specification, illustrate one or more embodiments of the present invention and, together with detailed description, serve to explain the principles and implementations of the invention.

FIG. 1 is an illustration of ENeedsOnline Reverse Auction Engine, Need Details window with Guiding Information.

FIG. 2 is an illustration showing bottom parts of the browser window not shown in FIG. 1.

FIG. 3 is an illustration showing bottom parts of the browser window not shown in FIG. 1.

FIG. 4 is an illustration of the change when the category is changed to “Trading Cards”.

FIG. 5 is an illustration of the Selection window.

FIG. 6 is an illustration of the Popular Guide Selections.

FIG. 7 is an illustration of the guide selection for the Loan Interest Rate Section.

FIG. 8 is an illustration of the guiding info by itself and not associated with any data field.

FIG. 9 is a XML document describing the guiding info for category Mortgage Loans, sub category “5 yr ARM 30 yr term”.

FIG. 10 is an illustration of what happens when a user clicks on one of the tabs.

FIG. 11 is an illustration of results returned from a search engine with guiding information and guide selections.

### REFERENCES CITED

U.S. PATENT DOCUMENTS

| | | | |
|---|---|---|---|
| 6992687 | January, 2006 | Proehl, et al. | 725/50 |
| 6983276 | January, 2006 | Tenorio | 707/7 |
| 6976266 | December, 2005 | Chaney, et al. | 725/39 |
| 6992687 | January, 2006 | Baird, et al. | 345/805 |
| 5146552 | September, 1992 | Cassorla, et al. | 715/512 |
| 5434965 | July, 1995 | Matheny, et al. | 715/710 |
| 5630125 | May, 1997 | Zellweger | 707/103R |
| 5632022 | May, 1997 | Warren, et al. | 715/776 |
| 6993712 | January, 2006 | Ramachandran, et al. | 715/513 |
| 6969092 | November, 2005 | MacWilliams, et al. | 283/36 |
| 6996564 | February, 2006 | Lester, et al. | 707/10 |
| 6990676 | January, 2006 | Proehl, et al. | 725/40 |

U.S. PUBLISHED APPLICATIONS

| | | |
|---|---|---|
| 20060026638 | February, 2006 | Stark; Korina J. B.; et al. |
| 20060026637 | February, 2006 | Gatto; Jean-Marie; et al. |
| 20060026636 | February, 2006 | Stark; Korina J. B.; et al. |
| 20060020538 | January, 2006 | Ram; Pranil; et al. |

### OTHER REFERENCES

1. www.consumerreports.org, ratings and reports

2. Teletrade's real price guide, www.teletrade.com, http://www.teletrade.com/coins/search.asp?pguide=1

### DETAILED DESCRIPTION OF PREFERRED EMBODIMENTS

Embodiments of the present invention are described herein in the context of a method and apparatus for emulating a competitive process. Those of ordinary skill in the art will realize that the following detailed description of the present invention is illustrative only and is not intended to be in any way limiting. Other embodiments of the present invention will readily suggest themselves to such skilled persons having the benefit of the disclosure. Reference will now be made in detail to the implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation—specific decisions must be made in order to achieve the developer's specific goals, such as compliance with application—and business related constraints, and that these specific goals will vary from one implementation to another and from one developer to another. Moreover, it will be appreciated that such a development effort might be complex and time consuming, but would nevertheless be routine undertaking of engineering for those of ordinary skill in the art having the benefit of this disclosure.

In accordance with the present invention, the components, process steps, and/or data structures may be implemented using various types of operating systems, computing platforms, computer programs, and or/general purpose machines. In addition, those of ordinary skill in the art will recognize that devices of a less general purpose nature such as hardwired devices, field programmable gate arrays (FPGAs), application specific integrated circuits (ASICs), or the like, may also be used without departing from the scope and spirit of the inventive concepts disclosed herein.

The purpose and idea of the invention is to use guiding info (patent pending U.S. 60/603,922) to present easy and understandable information about a particular category and sub category, using tabs to associate a guiding info section, each tab having a color and a code, and maybe guide selections. Guide selections are popular choices of products and information that enables a user to make an easy selection. The products could be consumer products like Televisions, MP3 or IPODs, Mortgage Loans, Mobile Phones and their plans, Autos and Auto Loans, etc.

Guiding Information is an expert engine that provides information about a category and sub categories. The Information makes it easier to choose a product and also increase ones knowledge about it. The product could be a consumer product such as Television, e.g. Panasonic Television. The Guiding Information shows information about the category Television, sub category Panasonic Television, and the different models available under Panasonic Television. The Guiding Information also provides the lowest and average prices for these models locally and nationally.

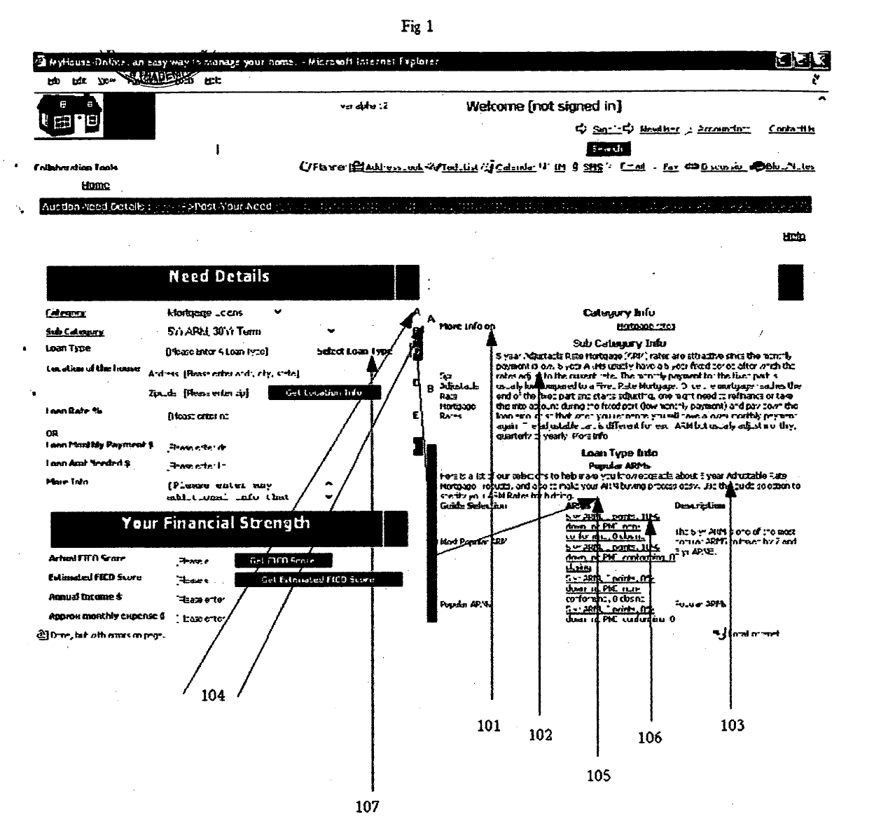

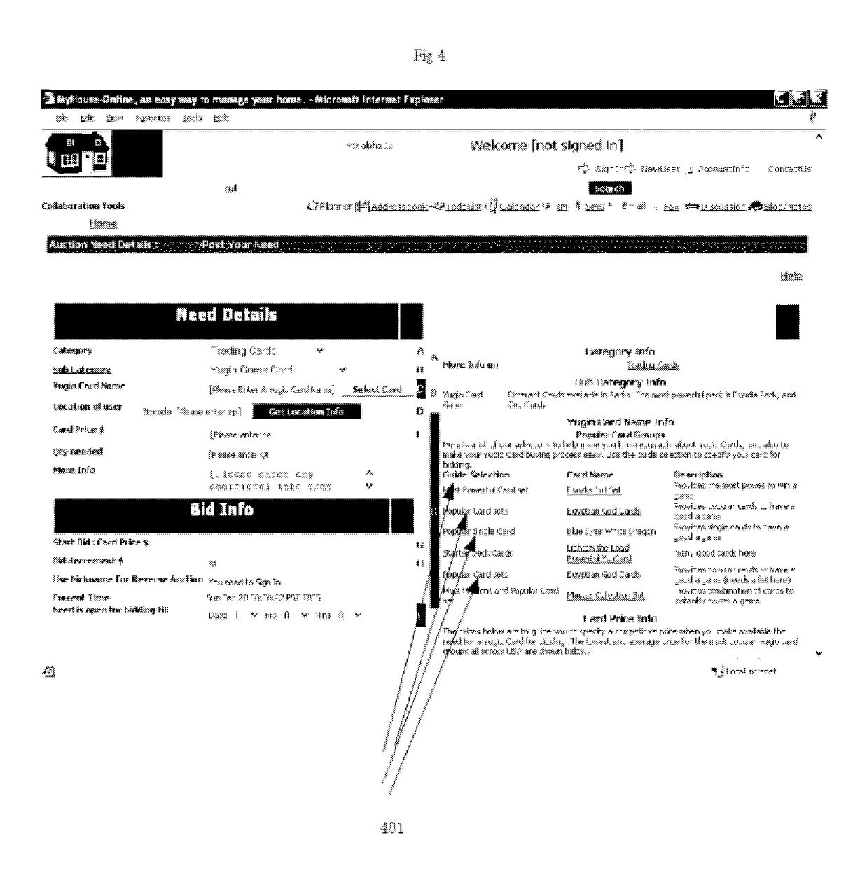

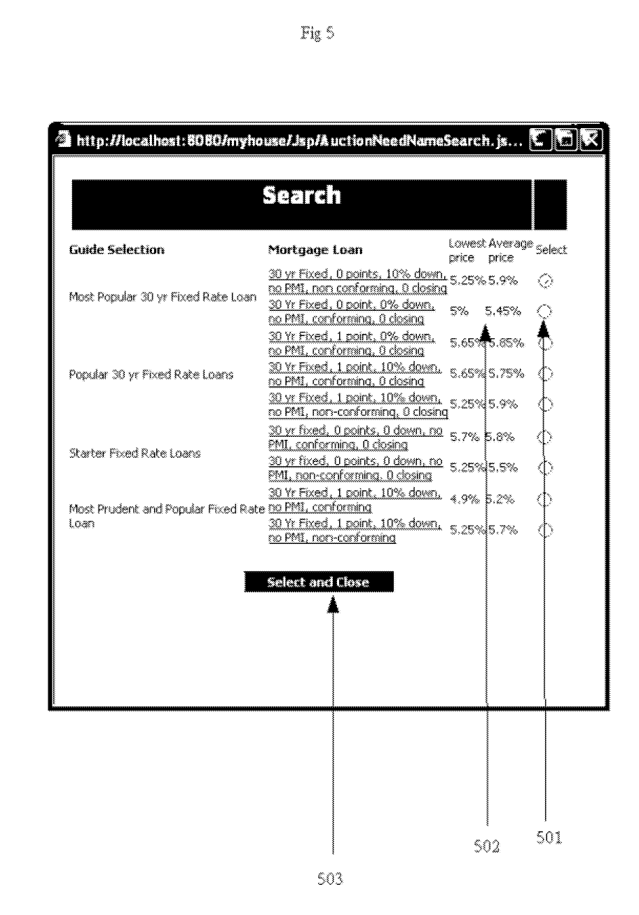

FIG. 1 is an illustration of ENeedsOnline Reverse Auction Engine Need Details window with Guiding Information. The figure illustrates a user trying to post a need for bidding. 101 shows the guiding info for Mortgage Loans category. 102 shows the sub category, 103 shows the Loan Type information. 104 is an association of the Mortgage Loan section to the data entry field, Category. The category shown is Mortgage Loans. Changing the category changes the guiding information. FIG. 4 is an illustration of the change when the category is changed to “Trading Cards”. Color tabs associate a field with the guiding information section. Tabs are also coded, and in this embodiment it is with alphabets. The association of the field tab and the guiding information section is left to the user to associate. This is triggered automatically as the user will match the color and the code to look at information. For e.g., to find more information about the category Mortgage Loans, the user will look at the tab associated with the category, code ‘A’, match it to the tab on the guiding information section, color and code ‘A’, and look for more information. 105 is showing the association of the Loan Type field with the guiding information section. If the user wants to find out more information about the types of loans available, the user can look at the association and will look at the color, in this case, color #6666FF, and letter C to associate information, and look at the different loan selections, and the information presented. This provides a very easy way to inform the user about the data that is needed. The user can look at the information on the right and understand the different loans available for selection and then make a selection from the list. The user can click on the URL link, 106, to get more information about a particular loan itself. Clicking on the loan selection can take the user to a customer site which might provide information about the type of loan and the terms associated with that particular loan. 107 is a button that the user can click to see the Loan Types in a selection window. The information in the selection window is again guiding information from sections ‘C’, and ‘D’. FIG. 5 is an illustration of the Selection window. The user selects one of the choices and closes the window. The selection allows the user to not only input the information about Loan Selection, it also provides input to the Loan Interest Rate field, and the Loan Amount field, and maybe other fields. The idea here is to provide an easy way for the user to get information about a field and select the information to input data needed.

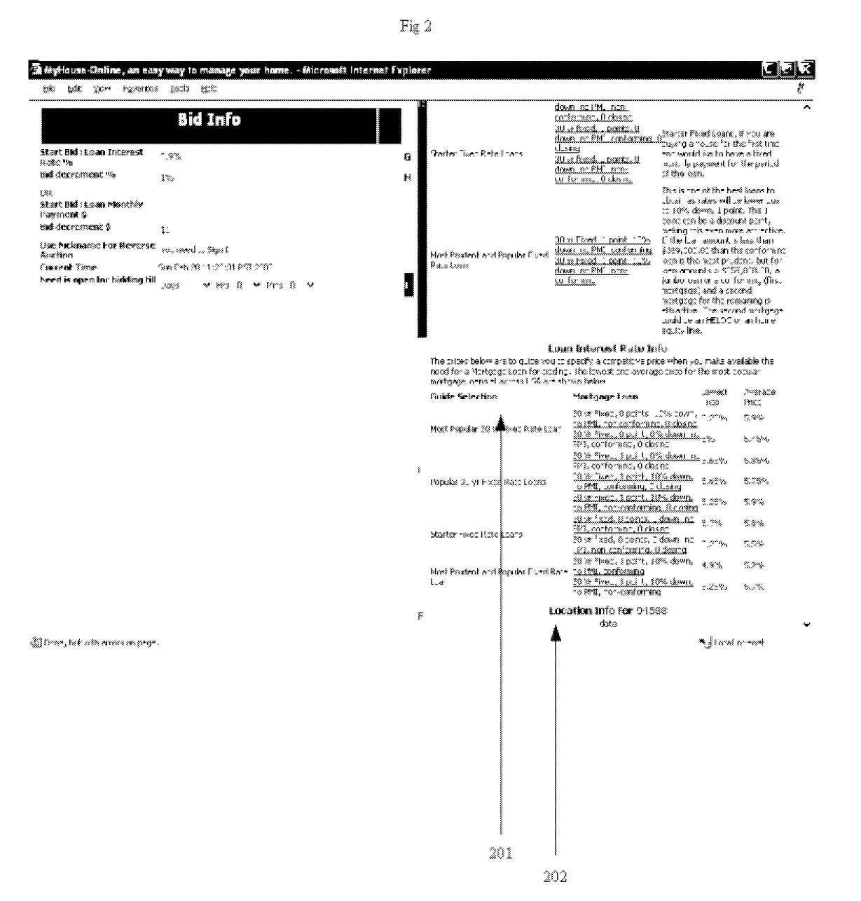

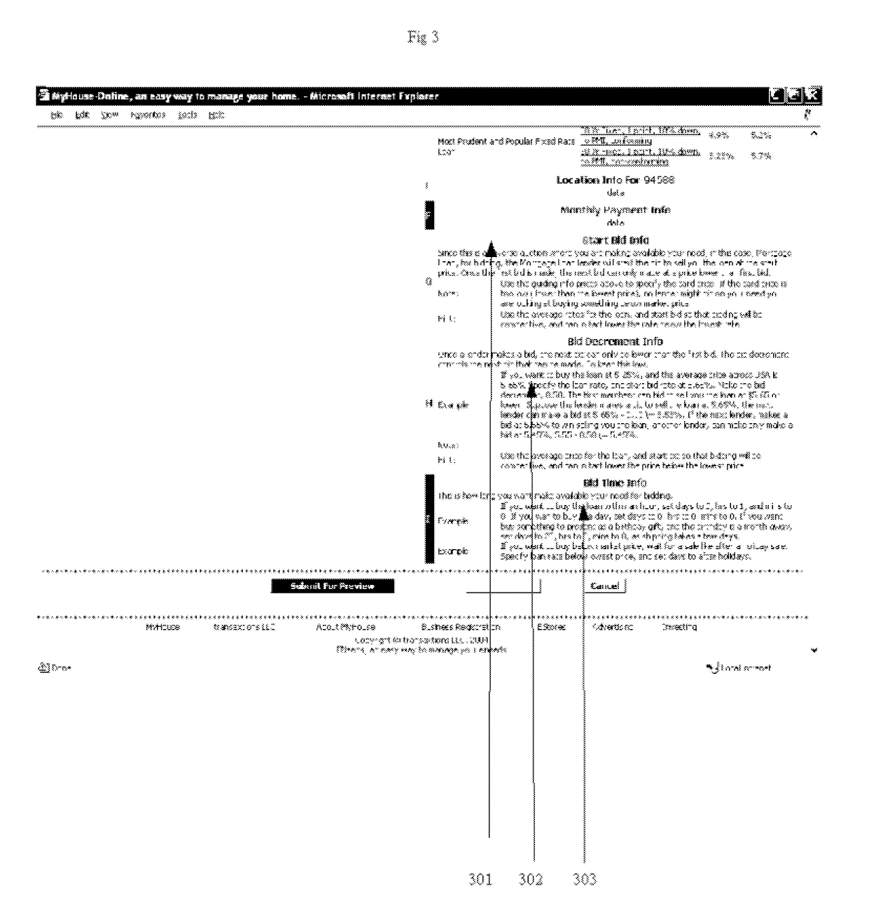

FIG. 2, FIG. 3 are illustrations showing bottom parts of the browser window not shown in FIG. 1. 201 is the Loan Rate section, 202 is the Location Info section. 301 is the Start Bid Info, 302 is the Bid Decrement info, 303 is the Bid Time info. 201 is associated with Loan Interest Rate field in the Need Details Window. The user can use the Guiding information associated with the field, tab color “burly wood”, code ‘E’ to look up more information about the interest rates available for a particular loan. The guiding information for Loan Interest Rate Info section also provides the lowest and average rates/prices for the selections shown, nationally. The lowest and average prices for a product allow the user get an idea of the competitiveness in the market and allows the user to input an interest rate that would be reasonable. 202 is the Location Info related to a zip code. This information is presented if the user wants to see information related to a location. The information can be local interest rates/prices for the Loan. 301 and 302 show that any field can be associated to a guiding info field using the color coded tabs.

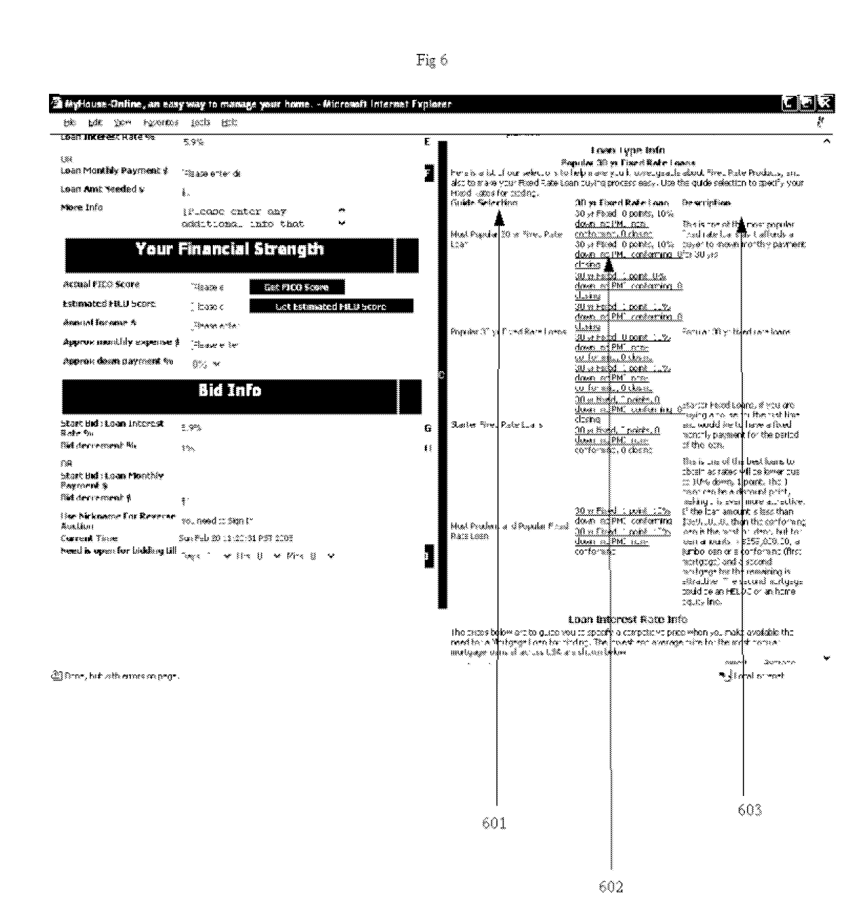

FIG. 6 is an illustration of the Popular Guide Selections. The guide selections are made based on popular choices of users. The choice for this could be rankings in consumer report, consumer guides, standard and poor, proprietary, etc. 601 is the guide selection column with popular selections. 602 is the items available under this selection. In this embodiment, the selection is about the most popular 30 yr fixed rate mortgage. The items under this selection like “30 yr fixed, 0 points, 10% down, no PMI, non-conforming, 0 closing”, “30 yr fixed, 0 points, 10% down, no PMI, conforming, 0 closing”, are shown. The selections could be multiple and each could have its own description in another embodiment. 603 is the description of the selections. The Guide selections provide selections for the most popular choices as well as starter choices to the most prudent and popular choice. 604 shows the guide selection for the Mortgage Loan category and 30 Yr Fixed sub category. This includes, “Most Popular 30 yr Fixed Rate Loan”, “Popular 30 yr Fixed Rate Loans”, “Starter Fixed Rate Loans”, “Most Popular and Prudent Fixed Rate Loan”. 401 shows the guide selections for the category Trading Cards, sub category “Yugio Game Cards”. The selections include, “Most Powerful Card Set”, “Popular Card Sets”, “Popular Single Cards”, “Starter Deck Cards”, and “Most Prudent and Popular Card Set”.

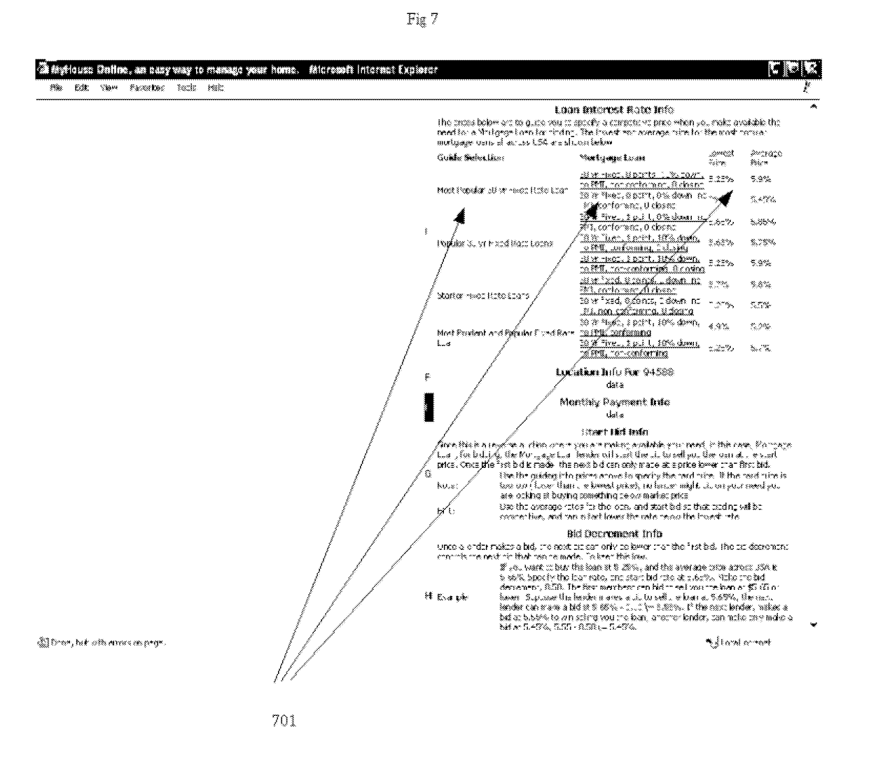

FIG. 7 is an illustration of the guide selection for the Loan Interest Rate Section. 701, has the popular guide selections but instead of the description column now has the lowest and average prices column. 501 is a popup Selection window showing information from Loan Types and Loan Interest Rate Section, but in addition has a selection column to enable selection of the choices listed. The selection could be the lowest or the average price, and in this embodiment the average price is selected.

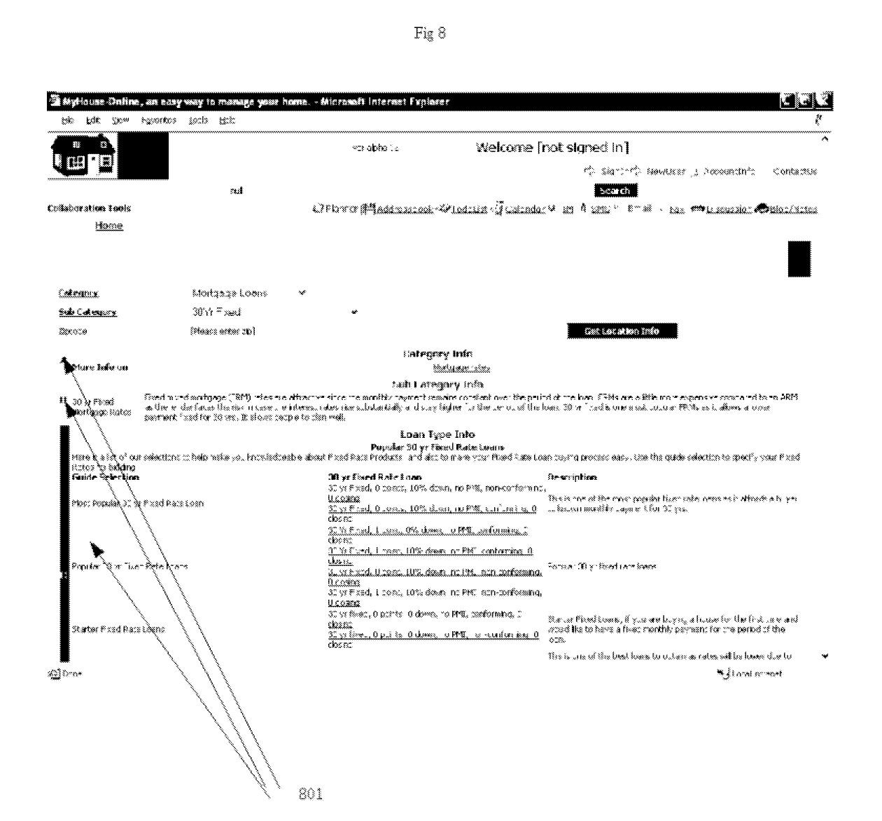

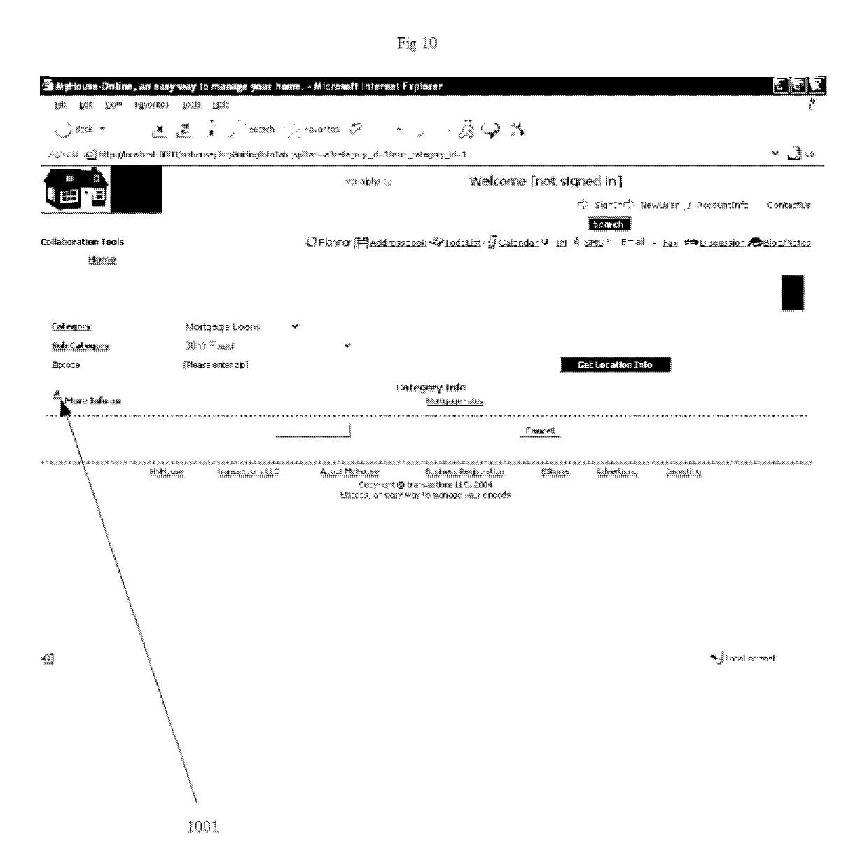

FIG. 8 is an illustration of the guiding info by itself and not associated with any data field. 801 shows the color coded tabs but no association. The tabs could be clicked on to open a web page showing more information about that particular section. FIG. 10 is an illustration of what happens when a user clicks on one of the tabs. 1001 shows tab A and Category Info section, Mortgage Loans. Only the tab section is shown, the other sections are not shown in this embodiment. The other sections could be shown in smaller font or just as tabs or tabs with section info, etc., in other embodiments.

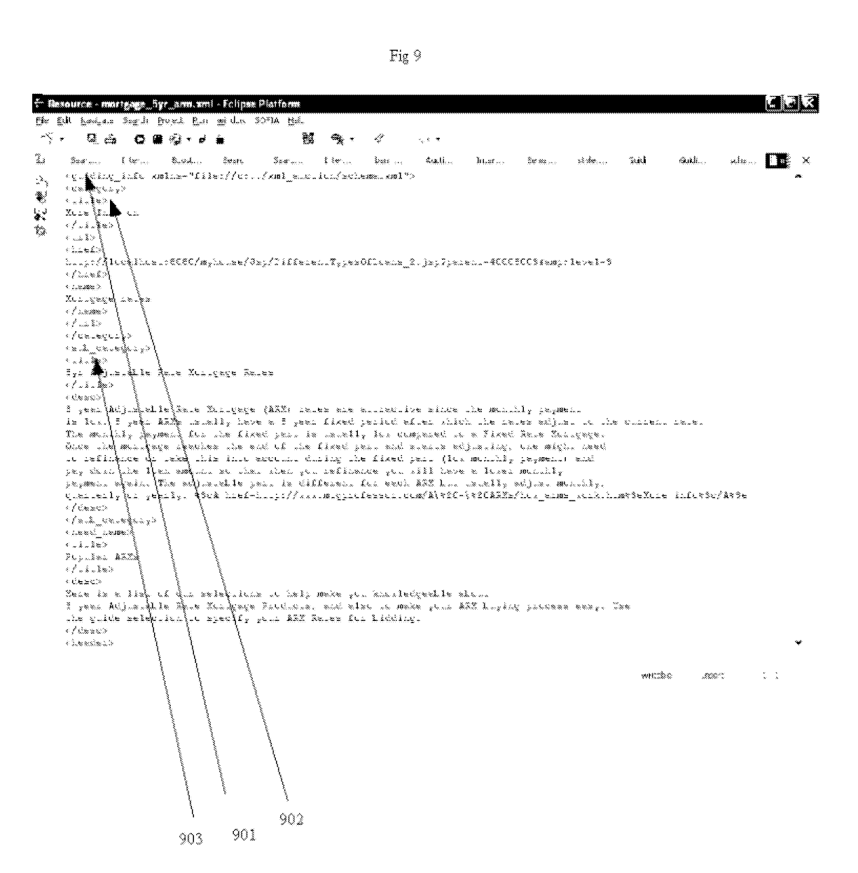

FIG. 9 is a XML document describing the guiding info for category Mortgage Loans, sub category “5 yr ARM 30 yr term”. 901 is the root node, guiding info, 902 is the category node, Mortgage Rates, and 903 is the sub category node, 5 yr Adjustable Rate Mortgage. The other nodes are not shown in the Figure. The XML document is parsed using a GuidinglnfoXml object. The XML document is passed as a String parameter to the constructor. The XML document can be retrieved from a database or from other data stores. The GuidinglnfoXml builds a DOM using the org.jdom.input.DOMBuilder object. Once the DOM is built any node can be accessed and rendered or accessed for its value. To draw the category node, the drawCategoryNode is called with a PrintWriter object as a parameter. The PrintWriter object is supplied by the AuctionNeedDetailController. This allows flexibility of use, and so could be used anywhere a PrintWriter object can be used. This method renders HTML but it could be used to render other types also. The root element is first obtained using the getRootElement method. Next an iterator to iterate over the children is obtained using the getchildren.lterator. The iterator is used to obtain the child element using the next() method, and the returned Element is checked to see if it is the “Category” node. If it is the category node, the iterator to iterate over the Category children is obtained, again using getchildren.iterator. The child element is retrieved using the next method, and this is compared to see if the node is the “title” node, and if it is, the text is retrieved using the getTextNormalize method. The text is rendered as HTML using the PrintWriter object. If the node is a “url” node, the getchildren.iterator is used to obtain the child elements. The child elements href and name are rendered using the PrintWriter object. The other nodes like SubCategory, Need Name. Need Rate, Start Bid Node, Bid Decrement Node, Bid Time Node, etc. are rendered similarly.

Another way to render a node is to start directly from an element and render the child nodes instead of starting from the root element. The drawNeedRateNode uses this method to render its children. The parameters to this method are the PrintWriter Object, SubCategoryHdrs, DatabaseUtil, and the Element. The element's children are obtained using the getchildren.iterator method. The child element is checked to see if it is the header node. If it is the header node, the header children is again obtained using the getchildrent.iterator method. The child element is checked to see if it is the “name” node and rendered using the PrintWriter object. Next the group node is rendered. If the child element is not a header node but a listp node, its children are again obtained using the getchildren.iterator. The child element is obtained using the next method. The getchildren.iterator is again used to obtain the children. If the child element is the name node, it is rendered using the PrintWriter object. If the child element is a pricelist node, the children are again obtained using the getchildren.iterator method. The child element price_node is obtained and the children under this node is again obtained using getchildren.iterator method. The child element url is rendered by rendering href and name nodes. If the child element is price, its children are again obtained. The child elements low and avg are rendered. The type of low and avg is determined by calling the DatabaseUtils.getFormattedValue method. The parameters is the node text, and type obtained from SubCategoryHeaders.need_rate_type attribute.

FIG. 1 shows an implementation of the Guidinginfo object. In this embodiment, a GuidinglnfoXml object is instantiated in the pageRequested method of the AuctionNeedDetailController object. The pageRequested method is called when the user clicks on a link to post a bid. This takes the user to the Need Details Window with Guiding Information. The fields associated with the NeedDetails Window are rendered first and then the Guiding Information is rendered. The color coded tabs are HTML table data cells. The Guiding Info XML document is retrieved from the database using the category and sub category ids. The category and sub category ids are passed as parameters in the URL.

The XML document is passed as a String parameter to the GuidinglnfoXml object. The different sections are rendered by calling different methods drawCategoryNode, drawSubCategoryNode, drawNeedNameNode, drawNeedRateNode, drawStartBidNode, drawBidDecrementNode, drawBidTimeNode, etc. The methods are implementations to parse the XML document nodes. So as nodes are added/modified to the document new implementations maybe needed.

It should be noted that in the described embodiments, an object oriented programming environment has been described to discuss the present invention. Object Oriented Constructs such as methods, object, attribute, exceptions have been used to describe how the invention works. However, this can also be implemented in other programming environments and languages. It should also be noted that this is an illustration of one of the embodiments. The elements can be retrieved using other methods, and rendered or passed on to other methods or objects, and should not be limited to as shown.

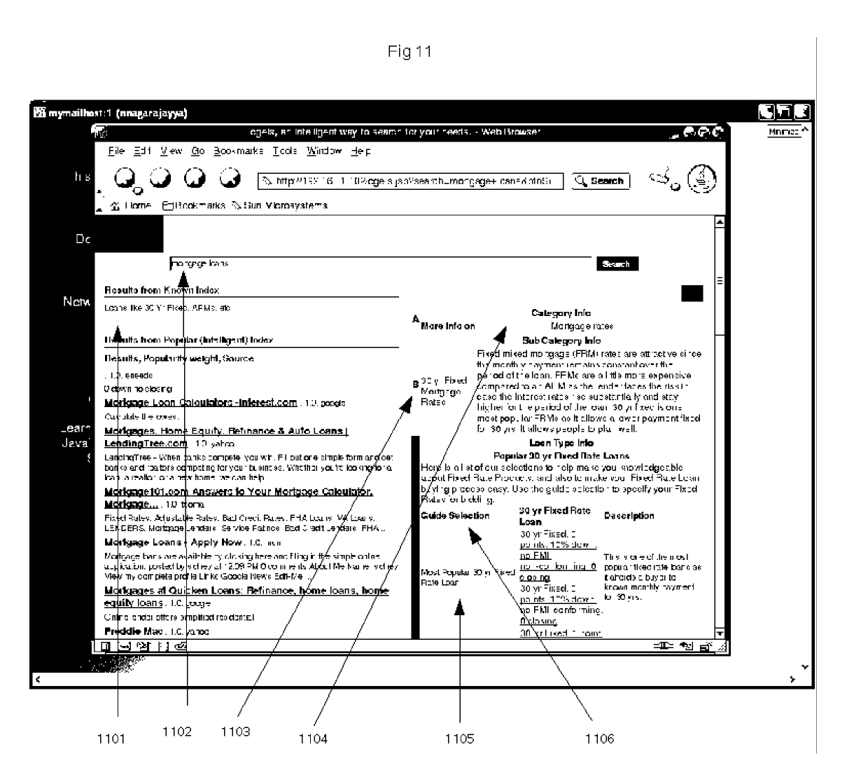

FIG. 11 shows an embodiment of guiding information, guide selections being returned as input to a “mortgage loan” query. This embodiment shows the use of guiding information tabs with guide selections to associate search results with the input mortgage loans. 1102 shows the input “mortgage loans”, 1101 shows the results from the Known Index, see Intelligent Search with Guiding Info, application Ser. No. 11/306332 for more information about Known Index, 1104 is more information about the category Mortgage Loan, 1103 is more information about the Sub Category “30 yr Fixed Rate Loans”, 1106 is the guide selections column for the category and 1105 is the most popular guide selection for the Sub Category.

While embodiments and applications of this invention have been shown and described, it would be apparent to those skilled in the art having benefit of this disclosure that many more modifications than mentioned above are possible without departing from the inventive concepts herein. The invention, therefore, is not to be restricted except in the spirit of the appended claims.

Definition List 1

| Term | Definition |
|---|---|
| GET | A HTTP method to send/get data from a |
| | server |
| POST | A HTTP method to send/get data from a |
| | server |
| HTTP | A TCP/IP based text request/response |
| | protocol that allows web browsers to show |
| | data from a server called a web server |
| Session | AJ2EE HTTP session object, and provides a |
| | way to identify a user across more than one |
| | page request or visit to a Web site and to |
| | store information about that user. |
| J2EE | Java 2 Platform, Enterprise Edition defines |
| | the standard for developing component- |
| | based multitier enterprise applications |
| Jsp | JavaServer Pages technology provides a |
| | simplified, fast way to create dynamic web |
| | content |
| Salmon Open Source | An open source MVC J2EE server framework |
| Framework | for building J2EE applications |
| URL | Uniform Resource Locator |
| XML | Extensible Markup Language |
| TCP | Transmission Control Protocol |
| IP | Internet Protocol |
| Java | An object oriented programming language |
| MVC | Model View Controller paradigm |
| Web | World wide web, www, also known as the |
| | internet |
| Browser | A Graphical User Interface for viewing |
| | content called html on the web |
| ENeedsOnline | An online marketplace where buyers and |
| | sellers can make available a need, |
| | http://www.eneedsonline.com |

What is claimed is:

1. A method for searching or input or browsing for information on the internet or intranet in a computer based system, the method comprising:
associating information sections using color coded tabs, associating data input fields with the said information sections using the color coded tabs, presenting information using color coded tabs so that a user becomes knowledgeable about the association; said color coded tabs contain input fields, guiding information and guide selections; said guiding information includes description, competitive pricing, media and guide selections; said guide selections provide a selection process so that a user can make a selection that serves as input to a single or multiple fields; said guide selection information could be national and local with and without association; said guide selections are popular selections like starter, high end, most popular, popular and prudent, popular, prudent, etc.

2. A method according to claim 1 wherein input fields are rendered with guiding information;
said input fields and guiding information sections are tagged with colored coded tabs; said color coded tabs associate an input with guiding information making a user knowledgeable about the input to be made.

3. A method according to claim 1 wherein input fields are rendered with guiding information sections and colored coded tabs; said guiding information section provides guide selections where guide selections are popular selections easing product selection; said guide selections with guiding information make the user knowledgeable about the market and allow a guide selection to be selected.

4. A method according to claim 1 wherein results are rendered with guiding information tabs; said results might be from a search engine or a data source; said results with guiding information tabs make the user knowledgeable about the market; said guiding information tabs might include guide selections to further aid the user.

5. A method according to claim 1 wherein guiding information tabs and guide selections are rendered using popup selection windows; said guiding information tabs and guide selections can be used to return results; said results can be input into data fields; said popup window with guiding information tabs and guide selections make the user knowledgeable about the selections and aids the user in making a selection.

6. A method according to claim 1 wherein guiding information and guide selections are rendered using color coded tabs; said tabs can be clicked to expand on the guiding information section allowing more information to be presented; said information can be presented in the same window or through a popup window.

7. A program storage device readable by a machine, tangibly embodying a program of instructions readable by a machine to perform a method of searching or input or browsing for information on the internet or intranet; said method allows associating information sections using color coded tabs, associate data input fields with said information sections using the color coded tabs, present information using color coded tabs so that a user becomes knowledgeable about the association; said color coded tabs contain input fields, guiding information and guide selections; said guiding information includes description, competitive pricing, media and guide selections; said guide selections provide a selection process so that a user can make a selection that serves as input to multiple fields; said guide selection information could be national and local with and without association; said guide selections are popular selections like starter, high end, most popular, popular and prudent, popular, prudent, etc.

8. A program storage device according to claim 7 wherein input fields are rendered with guiding information; said input fields and guiding information sections are tagged with colored coded tabs; said color coded tabs associate an input with guiding information making a user knowledgeable about the input to be made.

9. A program storage device according to claim 7 wherein input fields are rendered with guiding information sections and colored coded tabs; said guiding information section provides guide selections where guide selections are popular selections easing product selection; said guide selections with guiding information make the user knowledgeable about the market and allow a guide selection to be selected.

10. A program storage device according to claim 7 wherein results are rendered with guiding information tabs; said results might be from a search engine or a data source; said results with guiding information tabs make the user knowledgeable about the market; said guiding information tabs might include guide selections to further aid the user.

11. A program storage device according to claim 7 wherein guiding information tabs and guide selections are rendered using popup selection windows; said guiding information tabs and guide selections can be used to return results; said results can be input into data fields; said popup window with guiding information and guide selections make the user knowledgeable about the selections and aids the user in making a selection.

12. A program storage device according to claim 7 wherein guiding information and guide selections are rendered using color coded tabs; said tabs can be clicked to expand on the guiding information section allowing more information to be presented; said information can be presented in the same window or through a popup window.

13. An apparatus for making available a method of searching or input or browsing for information on the internet or intranet in a computer based system; the apparatus comprising:
Data Input Fields;
Color Coded Tabs;
Guiding Information;
Guide Selections;
Said apparatus is used to associate information sections using color coded tabs, associate data input fields with said information sections using the color code tabs, present information using color coded tabs so that a user becomes knowledgeable about the association; said color coded tabs contain input fields, guiding information and guide selections; said guiding information includes description, competitive pricing, media and guide selections; said guide selections provide a selection process so that a user can make a selection that serves as input to multiple fields; said guide selection information could be national and local with and without association; said guide selections are popular selections like starter, high end, most popular, popular and prudent, popular, prudent, etc.

14. An apparatus as in claim 13 wherein input fields are rendered with guiding information; said input fields and guiding information sections are tagged with colored coded tabs; said color coded tabs associate an input with guiding information making an user knowledgeable about the input to be made.

15. An apparatus as in claim 13 wherein input fields are rendered with guiding information sections and colored code tabs; said guiding information section provides guide selections where guide selections are popular selections easing product selection; said guide selections with guiding information make the user knowledgeable about the market and allow a guide selection to be selected.

16. An apparatus as in claim 13 wherein results are rendered with guiding information tabs; said results might be from a search engine or a data source; said results with guiding information tabs make the user knowledgeable about the market; said guiding information tabs could include guide selections to further aid the user.

17. An apparatus as in claim 13 wherein guiding information tabs and guide selections are rendered using popup selection windows; said guiding information tabs and guide selections can be used to return results; said results can be input into data fields; said popup window with guiding information and guide selections make the user knowledgeable about the selections and aids the user in making a selection.

18. An apparatus as in claim 13 rendering guiding information and guide selections using color coded tabs; said tabs can be clicked to expand on the guiding information section allowing more information to be presented; said information can be presented in the same window or through a popup window.
